(19) United States
(12) Patent Application Publication
(10) Pub. No.: US 2006/0053424 A1
(43) Pub. Date: Mar. 9, 2006

(54) Load balancing devices and method therefor

(76) Inventors: Tommi Koistinen, Vantaa (FI); Karo Halmet, Kerava (FI); Henrik Lepanaho, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/518,930

(22) PCT Filed: Jun. 28, 2002
(86) PCT No.: PCT/IB02/02492

§ 371 Date: Jan. 13, 2005

(51) Int. Cl. G06F 9/46

(52) U.S. Cl. 718/105

(57) ABSTRACT

A method of balancing the load of resources in a packet switched connection within a communication system, said system comprising processing units (11; 21) for performing communication, at least one load balancing unit (12; 22) for distributing the load to said processing units (11; 21), and a data storage (14; 24), said method comprising the steps of: obtaining a current connection state as well as a current load state of said processing units from said data storage (14; 24); selecting by said load balancing unit (12; 22) a processing unit on a per-packet basis; and maintaining information about the load state of each processing unit (11; 21) so that said selecting step is performed by selecting a processing unit to serve and process a respective packet based on the load state.

### FIELD OF THE INVENTION

The present invention relates to an automated load balancing and substantially streamlined resource management in a communication system. The present invention is particularly applicable when high-speed packet based links are interfaced with signal processing resources.

### BACKGROUND OF THE INVENTION

Typically, in present communication systems a resource management functionality plays a significant role in any network element providing heterogeneous signal processing services. This means that several processing units must be dedicated to provide the resource management functionality. Also, quite a high amount of the internal communication bandwidth must be reserved for exchanging the resource management related control messages. However, increasing the number of the media processing units may cause the resource manager to become a bottleneck that may mean a reduced overall cost-efficiency, and, in practice, longer latency times when responding to new service requests.

FIG. 3 depicts an arrangement where a load balancing device 32 is used in a conventional way. Reference numeral 33 designates a device for routing packets of a communication connection. Particularly, according to this prior art, the processing unit is selected out of a plurality of processing units 31 on a per-connection basis.

However, the prior art described above suffers from the following drawbacks. This conventional resource management system is not scaleable which means that there is a large number of dedicated units as well as a large number of control messages. In addition, delays in responding to service requests occur. Moreover, the utilization of statistical multiplexing inflicts difficulties.

Particularly, the processing times in the packet switched connection according to the prior art are not deterministic. Specifically, in the conventional arrangement, one digital signal processor (DSP) is receiving and processing several channels (e.g. 8 . . . 16) simultaneously. This means that a packet must wait a non-deterministic time before it is processed, that is, depending on how many channels are processed before that specific channel.

### SUMMARY OF THE INVENTION

Accordingly, it is an object of the present invention to overcome these shortcomings of the prior art and to provide a streamlined and cost-effective way to manage the available resource pool.

According to the present invention, the object is solved by providing a method of balancing the load of resources in a packet switched connection within a communication system, said system comprising processing units for performing communication, at least one load balancing unit for distributing the load to said processing units, and a data storage, said method comprising the steps of: obtaining a current connection state as well as a current load state of said processing units from said data storage; selecting by said load balancing unit a processing unit on a per-packet basis; and maintaining information about the load state of each processing unit so that said selecting step is performed by selecting a processing unit to serve and process a respective packet based on the load state.

Here, the data storage can be accessed to by said load balancing unit or said processing units. Further, the information about the load state may be maintained as a Boolean state, i.e. to indicate free or not free.

The selection of a processing unit can be done in a round-robin fashion.

Further, a supported service profile for each processing unit can be maintained in addition. In this case, the supported service profile can be used as additional selection criteria.

In the method according to the present invention, the load balancing unit can obtain a load state from each processing unit upon a hardware based mechanism or a packet based mechanism. In the latter case, a load state of a processing unit may be inserted into a packet processed by said unit or a packet returned by a processing unit may be interpreted as a flag for a free resource.

Besides, should excess traffic occur it can be redirected to another load balancing unit, wherein said excess traffic would be defined upon the number of active processing units.

The method according to the present invention provides a more effective utilization of the media processing resources, since the resources are managed on the basis of an effective resource allocation of the whole network element instead of managing resource allocations of single processing units. Thus, the benefits of a statistical multiplexing can be exploited easily.

An additional benefit is the deterministic, i.e. optimal, processing time that a single packet always encounters, since a processing unit serves only one packet at a time.

Moreover, with the method according to the present invention, the processing delay of a received packet is always optimal and very constant. Consequently, a constant processing time minimizes unwanted jitter and other possible fluctuations of the traffic flow.

According to the present invention, the object is further solved by providing a device unit for serving and processing packets of a communication connection, comprising means adapted to inform a load state of said device to a balancing unit; and means adapted to obtain a state of said communication connection.

In this processing device unit, said obtaining means can be adapted to retrieve said communication connection state from a data storage or from a packet being under processing.

According to the present invention, the object is still further solved by providing a device unit for balancing a load of each of multiple processing units-performing a packet switched communication connection, comprising: means for maintaining a load state of each of said processing units; and means adapted to select a processing unit on the basis of a respective load state.

In this balancing device unit, a load state of a processing unit may be contained in a table. The state can be expressed as a Boolean state or as value which corresponds to the percentage of load.

Further, said selecting means can be adapted such that a processing unit is selected also on the basis of a parameter indicating the service profile supported by a respective processing unit. In this case, said parameter could be contained in a table.

As a modification, the load balancing device unit may further comprise means adapted to insert a communication connection state into a packet to be routed.

In a preferred embodiment, the processing units are comprised of multicore digital signal processing means having a shared data storage for all cores, whereby said device comprises a first level of load balancing for selecting a digital signal processing means and a second level of load balancing for selecting a single core. As another modification, the load balancing device unit may further comprise means for redirecting excess traffic to another load balancing device unit according to the present invention, wherein said excess traffic is defined upon the number of active processing units.

Furthermore, a system adapted to perform the method according to the present invention and/or comprising one or more devices according to the present invention does also solve the object.

### BRIEF DESCRIPTION OF THE DRAWINGS

Further details and advantages of the present invention as well as further modifications thereof are apparent from the detailed description of the preferred embodiments which are to be taken in conjunction with the appended drawings, in which:

FIG. 1 shows a first embodiment of the present invention;

FIG. 2 shows a second embodiment of the present invention; and

FIG. 3 shows a conventional arrangement.

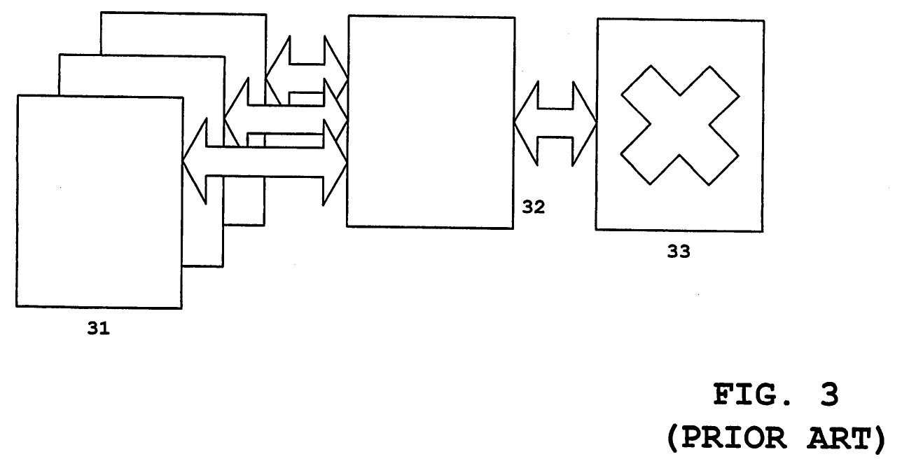

### DETAILED DESCRIPTION OF THE PREFERRED EMBODIMENTS

The present invention introduces a load balancing unit (or DSP selector) in front of the DSP resource pool. The main idea behind the load balancing unit is to remove (or at least substantially reduce) the need for separate and poorly scaleable resource management layers.

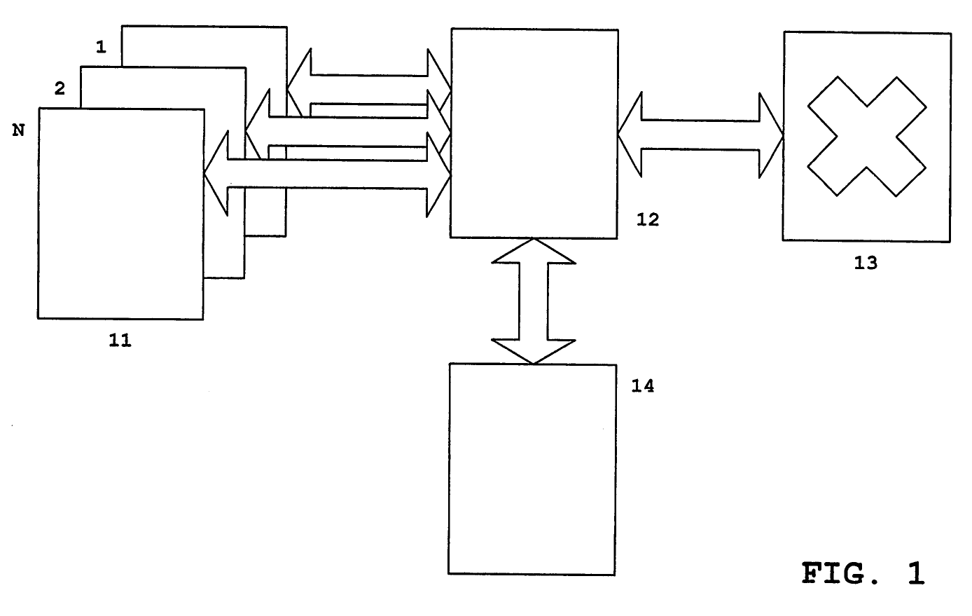

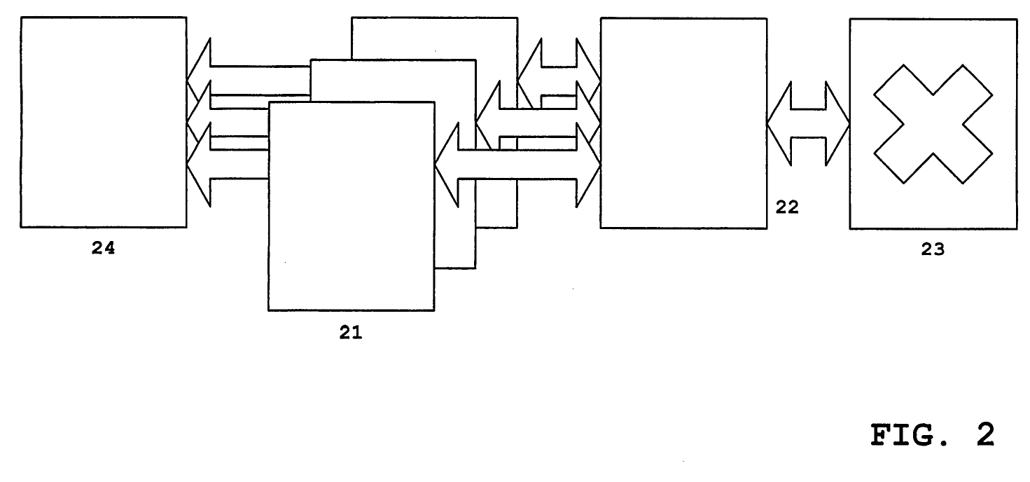

The FIGS. 1 and 2 present the two preferred implementation options. It is common to both implementations that the processing unit is selected by the load balancing unit on a per-packet basis.

Specifically, in FIG. 1, reference numeral 11 designates 1 . . . N processing units for serving packets of a communication connection; reference numeral 12 designates the load balancing unit; reference numeral 14 designates a data storage; and reference numeral 13 designates a routing device for routing packets of a communication connection.

According to the arrangement depicted in FIG. 1, a connection state is stored in the data storage 14 by the load balancing unit 12 as will be apparent from the description given below.

Next, in FIG. 2, reference numeral 21 designates 1 . . . N processing units for serving packets of a communication connection; reference numeral 22 designates the load balancing unit; reference numeral 24 designates a shared data storage; and reference numeral 23 designates a routing device for routing packets of a communication connection.

According to the arrangement depicted in FIG. 2, a connection state is stored in the shared data storage 24 by processing units 21 as will be apparent from the description given below.

What is common to both implementations is that the load balancing unit keeps track of the total utilization of the processing units and this overall load information can be provided for other network management processes. Specifically, the arrangement that is depicted in FIGS. 1 and 2 provides a streamlined and more cost-effective way to manage the available resource pool. The main idea behind the present invention is that the single processing units are not dedicated to serve a specific connection (or a call). Instead, the load balancing unit selects any free processing unit oh a per-packet basis. The current connection state is obtained from a data storage that may be located either at the load balancing unit (FIG. 1) or at the processing units (as shared memory as is depicted in FIG. 2). In the former case, it would be essential that the connection state is inserted into the packets by the load balancing unit. The load balancing unit maintains the load state of each processing unit (preferably as a Boolean state) and selects any of the free (=non-active) processing units to serve and process the received packet. The selection of a processing unit, e.g. in a round-robin fashion, results the automatic load balancing for the system. A supported service profile for each processing unit (e.g. only GSM codecs) may also be maintained and used as an additional selection criteria.

Furthermore, the conveyance of the load state from each processing unit to the load balancing unit may happen either by a hardware based mechanism (such as dedicated pin, shared memory etc.) or a packet based mechanism (such as inserting the load state to returning (processed) packets or just interpreting a returning packet as a flag for a free resource). The load balancing unit and the processing units may be interconnected for example with Ethernet/IP, thus they do not require a physical co-location.

Some functionalities that the processing units, the load balancing unit and the data storage provide in preferred embodiments of the invention are outlined in the following.

The processing unit implements a mechanism to inform the load status to the load balancing unit which can be a hardware based mechanism (dedicated pin, shared memory etc.) or a packet based, e.g. inserting the status in the processed packets. Further, the processing unit comprises means for obtaining the connection state from the data storage or from the received packet.

The load balancing unit which can also be one of the processing units implements a table that contains the load status of each DSP unit in a Boolean format (free or not free) or as a percentage of load (0 . . . 100% load). Further, it comprises means for selecting a resource based on the load status, wherein a parameter that indicates the supported service profile for each processing unit (e.g. only EFR codec) may also be used as an additional selection variable. Optionally, the load balancing unit may also comprise means for inserting the connection-state to a routed packet.

The data storage has to maintain the connection states by mapping them to suitable connection identifiers such as UDP ports and may lock the states in order to handle bursts of packets.

While the above may be considered as a basic arrangement according to the present invention, further developments of the same invention may be as follows.

Since the state-of-the art signal processors consist of multiple cores (e.g. 4-8) per one physical chip, one possibility could be to implement the load balancing unit functionality inside each multi-core DSP device which usually have a shared memory (data storage) for all cores. This way, there would be two levels of load balancing: one for selecting the DSP and a second level for selecting a single core.

In addition, it would also be preferred to have a redirecting functionality. That is, the excess traffic of a first load balancing unit could be redirected to another load balancing unit if a certain limit (or load) is exceeded, i.e. when all or most of the processing units are active when a new packet arrives.

According to the above, the benefits of a streamlined resource management, an automated load balancing between a high number of processing units, a more efficient utilization of the DSP resources resulting in a statistical multiplexing with a high number of processing units managed as a whole, the guaranteeing of a deterministic processing delay for each packet leading to a minimum delay and a smooth traffic pattern, and maintaining the possibility to still be able to dedicate processing units to a specific service as an optimal utilization of memory thus gaining a highest number of channels can be achieved.

According to the above, it is provided a method of balancing the load of resources in a packet switched connection within a communication system, said system comprising processing units 11; 21 for performing communication, at least one load balancing unit 12; 22 for distributing the load to said processing units 11; 21, and a data storage 14; 24, said method comprising the steps of: obtaining a current connection state as well as a current load state of said processing units from said data storage 14; 24; selecting by said load balancing unit 12; 22 a processing unit on a per-packet basis; and maintaining information about the load state of each processing unit 11; 21 so that said selecting step is performed by selecting a processing unit to serve and process a respective packet based on the load state.

While it is described above what is presently considered to be the preferred embodiments of the present invention, it is apparent to those skilled in the art that various modifications are possible to the present invention without departing from the spirit and scope thereof which is defined in the appended claims.

1-25. (canceled)

26. A method for balancing the load of resources in a packet switched connection within a communication system, said system comprising processing units for performing communication, at least one load balancing unit for distributing the load to said processing units, and a data storage, said method comprising the steps of:
obtaining a current connection state as well as a current load state of said processing units from said data storage;
selecting by said load balancing unit a processing unit on a per packet basis irrespective of a specific connection to which a respective packet belongs;
maintaining information about the load state of each processing unit so that said selecting step is performed by selecting a processing unit to serve and process a respective packet based on the load state.

27. A method according to claim 26, wherein said data storage is accessed to by said load balancing unit.

28. A method according to claim 26, wherein said data storage is accessed to by said processing units.

29. A method according to claim 26, wherein said information about the load state is maintained as a Boolean state.

30. A method according to claim 26, wherein a processing unit is selected in a round-robin fashion.

31. A method according to claim 26, wherein a supported service profile for each processing unit is maintained.

32. A method according to claim 31, wherein said supported service profile is used as additional selection criteria.

33. A method according to claim 26, wherein said load balancing unit obtains a load state from each processing unit upon a hardware based mechanism.

34. A method according to claim 26, wherein said load balancing unit obtains a load state from each processing unit upon a packet based mechanism.

35. A method according to claim 34, wherein a load state of a processing unit is inserted into a packet processed by said unit.

36. A method according to claim 34, wherein a packet returned by a processing unit is interpreted as a flag for a free resource.

37. A method according to claim 26, wherein excess traffic is redirected to another load balancing unit, said excess traffic being defined upon the number of active processing units.

38. A device unit for serving and processing packets of a communication connection, comprising:
means adapted to inform a load state of said device to a balancing unit; and
means adapted to obtain a state of said communication connection,
wherein said device unit is adapted to serve and process packets of plural connections.

39. A device unit according to claim 38, wherein said obtaining means is adapted to retrieve said communication connection state from a data storage.

40. A device unit according to claim 38, wherein said obtaining means is adapted to retrieve said communication connection state from a packet being under processing.

41. A device unit for balancing a load of each of multiple processing units performing a packet switched communication connection, comprising:
means for maintaining a load state of each of said processing units; and
means adapted to select a processing unit on the basis of a respective load state on a per packet basis irrespective of a specific connection to which a respective packet belongs.

42. A device according to claim 41, wherein a load state of a processing unit is contained in a table.

43. A device according to claim 41, wherein a load state of a processing unit is expressed as a Boolean value.

44. A device according to claim 41, wherein a load state of a processing unit is expressed as value which corresponds to the percentage of load.

45. A device according to claim 41, wherein said selecting means is adapted such that a processing unit is selected also on the basis of a parameter indicating the service profile supported by a respective processing unit.

46. A device according to claim 45, wherein said parameter is contained in a table.

47. A device according to claim 41, further comprising
means adapted to insert a communication connection state into a packet to be routed.

48. A device according to claim 41, wherein the processing units are comprised of multicore digital signal processing means having a shared data storage for all cores, whereby said device comprises a first level of load balancing for selecting a digital signal processing means and a second level of load balancing for selecting a single core.

49. A device according to claim 41, further comprising
means for redirecting excess traffic to another device, wherein said excess traffic is defined upon the number of active processing units.

50. A system adapted to perform a method according to claim 26.
